(19) United States
(12) Patent Application Publication
(10) Pub. No.: US 2009/0049411 A1
(43) Pub. Date: Feb. 19, 2009

(54) METHOD AND APPARATUS TO CONTROL PORTABLE DEVICE BASED ON GRAPHICAL USER INTERFACE

(75) Inventors: Jung-hyun SHIM, Seongnam-si (KR); Nho-kyung Hong, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/103,193

(22) Filed: Apr. 15, 2008

(30) Foreign Application Priority Data
Aug. 13, 2007 (KR) 2007-81444

(51) Int. Cl. G06F 3/048

(52) U.S. Cl. 715/841

(57) ABSTRACT

A method and apparatus capable of inputting various commands, such as rotating, touching, and clicking commands, in an integrated manner in order to select a displayed menu via a rotatable input interface having a sensor. The method includes moving through a menu displayed on a screen of the portable device in response to a rotation signal generated by a rotatable input interface included in the portable device; searching a plurality of lower lists included in the menu by using a sensor included in the input interface, in response to a direction signal indicating one direction; and selecting a desired item from the menu or the searched lower lists in response to an execution signal generated by the input interface.

### CROSS-REFERENCE TO RELATED APPLICATIONS

This application claims priority of Korean Patent Application No. 10-2007-0081444, filed on Aug. 13, 2007, in the Korean Intellectual Property Office, the disclosure of which is incorporated herein by reference in its entirety.

### BACKGROUND OF THE INVENTION

1. Field of the Invention

The present general inventive concept relates to a method and apparatus to control a graphical user interface (GUI)-based portable device, and more particularly, to an efficient handling method and apparatus capable of inputting various commands, such as rotating, touching, and clicking commands, in an integrated manner in order to select a menu displayed on a screen of a GUI-based portable device via a rotatable input interface having a sensor.

2. Description of the Related Art

Recently, portable devices, such as mobile phones, have been developed to have not only general main functions, e.g., functions of calling and sending text messages, but also functions of other electronic devices. For example, a mobile phone may have various functions, such as reproduction of MP3 music files (MP3 player), video recording and reproducing (digital camera), electronic dictionary functions, Internet web surfing, or digital TV functions. A basic Graphical User Interface (GUI)-based menu is displayed on the screen of such a portable device.

As the performance of portable devices, such as MP3 players, portable multimedia players (PMPs), and mobile phones, have increased, the total number of device functions has increased but the physical size of the devices has decreased. Thus research has been conducted into a method of mapping various functions to a limited number of buttons.

Although development of technology allows various functions to be integrated into a portable device or reduces the size of the portable device, the demand increases for user interfaces via which a user can rapidly and easily process a user input for performing complicated functions and control a terminal. For example, there is a growing need for a user interface which reduces the total number of key inputting steps that a user must perform in order to perform a particular operation and to easily manage, search, and reproduce a large number of digital content media, such as photos, moving pictures, music, and email.

In the case of a portable terminal, an increase in the total number of buttons for inputting such various functions has resulted in a complexity in user inputting due to the limited size of devices. In contrast, a decrease in the total number of buttons for inputting such various functions has resulted in an increase in the total number of times key inputting is necessary in order to perform a particular function.

Referring to FIG. 1A, a conventional input interface 110 with five navigation buttons is illustrated and FIG. 1B illustrates an input interface 120 using a touch screen.

The input interface 110 with five navigation buttons is disadvantageous in that many manipulations are required and the distances between buttons are long when handling the input interface 110 and it occupies a large space in a portable device.

The input interface 120 using a touch screen is disadvantageous in that fingerprints may be left on a screen or a part of a main screen image may be hidden by popup menus 121 and 122, since a menu is directly selected on the screen by using a finger or the like.

### SUMMARY OF THE INVENTION

The present general inventive concept provides an efficient controlling method and apparatus capable of inputting various commands, such as rotating, touching, and clicking commands, in an integrated manner in order to select a menu displayed on a screen of a graphical user interface (GUI)-based portable device via a rotatable input interface having a sensor.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of controlling a GUI (graphical user interface)-based portable device, the method including moving through a menu displayed on a screen of the portable device in response to a rotation signal generated by a rotatable input interface included in the portable device; searching a plurality of lower lists included in the menu by using a sensor included in the input interface, in response to a direction signal indicating one direction; and selecting a desired item from the menu or the searched lower lists in response to an execution signal generated by the input interface.

Moving through the menu may include navigating through the GUI or shifting indicia elements in the frame of the display unit, whether those indicia elements are graphical, highlighting or alphanumeric in nature, the elements being shifted in the same direction in which the input interface is rotated.

Searching a plurality of lower lists may include sequentially searching a plurality of lower lists one at a time in response to the direction signal based on a total number or arrangement of nodes of a sensor included in the input interface.

During the searching of a plurality of lower lists, the sensor in the input interface may be a touch sensor, and the plurality of lower lists may be searched in the same direction in which the nodes of the sensor are aligned.

During the selecting of a desired item, the execution signal may be a clock signal or a touch signal generated by the input interface, and the click signal or the touch signal may be differently generated according to the arrangement of nodes of the touch sensor included in the input interface.

The input interface may be a cylindrical or oval type bar interface. The input interface may be formed of a combination of a plurality of bar type interfaces.

The foregoing and/or other aspects and utilities of the present general inventive concept may be achieved by providing a handling apparatus which is included in a GUI (graphical user interface)-based portable device, the apparatus including a rotation signal processor shifting indicia elements associated with a menu displayed on a screen of the portable device in response to a rotation signal generated by a rotatable input interface included in the portable device; a direction signal processor capable of scrolling or searching a plurality of lower lists in the menu by using a sensor included in the input interface, in response to a direction signal indicating a direction; and an execution signal processor selecting a desired item from the menu or the searched lower lists in response to an execution signal generated by the input interface.

The rotation signal processor may shift elements in the display screen or navigate the menu in a direction in which the input interface is rotated.

The direction signal processor may scroll or search the lists in the direction signal proportionally to the total number or arrangement of nodes of the sensor in the input interface.

The sensor in the input interface may be a touch sensor, and the direction signal processor may search the lists in the same direction in which the nodes of the touch sensor are aligned.

The execution signal may be a clock signal or a touch signal generated by the input interface, and the execution signal processor may select the desired item in response to a click signal or a touch signal being differently generated according to the arrangement of nodes of the touch sensor included in the input interface.

The input interface may be a cylindrical or oval bar type interface, and be formed of a combination of a plurality of bar type input interfaces.

The foregoing and/or other aspects and utilities of the present general inventive concept may be achieved by providing a computer readable medium having recorded thereon a program for executing a method, the method including shifting indicia associated with a menu displayed on a screen of the portable device in response to a rotation signal generated by a rotatable input interface included in the portable device, searching a plurality of lower lists included in the menu in a direction using a sensor included in the input interface, in response to a direction signal indicating the direction and selecting a desired item from the menu or the searched lower lists in response to an execution signal generated by the input interface.

A method and apparatus for handling a GUI-based portable device according to the present general inventive concept are advantageous in that (i) navigation can be fast and efficiently performed by minimizing a number of manipulations required using an input interface via which various commands, such as rotating, touching and clicking, can be performed, (ii) a slim bezel design can be realized by minimizing the size of the input interface thereby maximizing a screen size compared to a product size, and (iii) characters can be input faster than when using a conventional inputting method.

The foregoing and/or other aspects and utilities of the present general inventive concept may be achieved by providing an apparatus to control a portable device including a frame, an input interface rotatably disposed on the frame and having a touch screen to generate a rotation signal, a directive signal, and a selective signal and a display unit disposed on the frame to display a menu according to the rotation signal and an item selected by the selecting signal.

Another aspect of the invention provides that the interface has a first length and the display unit has a second length to correspond to the first length.

The interface may have a rotation axis and the display unit displays the menu and the item along a display axis to correspond to the rotational axis.

The rotational axis may be parallel to the display axis.

The main body may include an opening and the input interface may include a round surface exposed through the opening.

Highlighting indicia generated by the display unit may be shifted from one graphical element to another graphical element in the display unit, in response to an execution signal generated by rotation of the input interface.

The display unit may generate a menu of graphical elements and selection of one graphical element followed by an execution signal generated by the input interface could then causes a list of items associated with the graphical element to be displayed in the display unit.

An execution signal may be generated when a user double clicks on the input interface.

One item from the list may be selected from the list when a user applies finger pressure along the input interface in a direction associated with the shifting of selection indicia with respect to the displayed list.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1A illustrates a conventional interface unit with five navigation buttons and FIG. 1B is another conventional input interface using a touch screen;

FIG. 2 is a flowchart illustrating a method of controlling a graphical user interface (GUI)-based portable device according to an embodiment of the present general inventive concept;

FIG. 3 illustrates an input interface employed in a portable device, along with a larger, perspective view of the input interface, according to an embodiment of the present general inventive concept;

FIGS. 4A-4C illustrate various methods of operating a menu displayed on a GUI screen according to an embodiment of the present general inventive concept;

FIGS. 5A-5F are a flowchart illustrating a method of selecting a menu from a user interface (UI) image, according to an embodiment of the present general inventive concept;

FIGS. 6A-6C illustrate a method of inputting characters according to an embodiment of the present general inventive concept;

FIG. 7A illustrates a 3×4 keyboard and FIG. 7B illustrates a QWERTY keyboard; and

FIG. 8 is a block diagram of a handling apparatus included in a GUI-based portable device according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

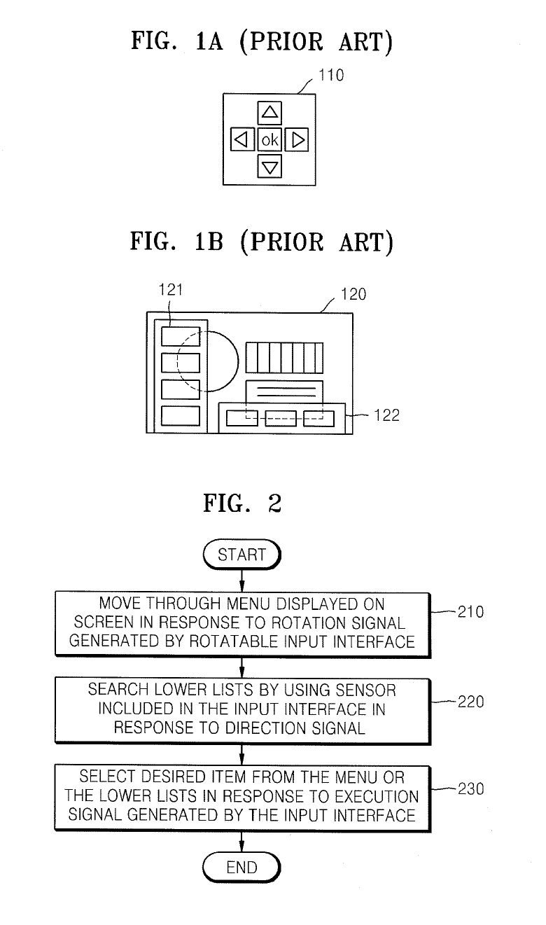

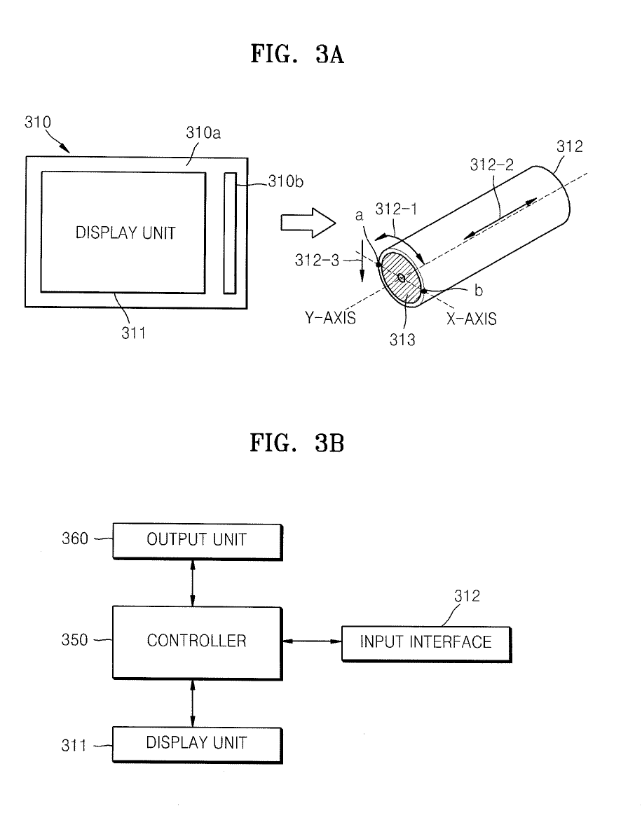

FIG. 2 is a flowchart illustrating a method of controlling or handling a graphical user interface (GUI)-based portable device 310 (see FIG. 3A) according to an embodiment of the present general inventive concept. The method of FIG. 2 includes navigating, shifting elements or moving through a menu displayed on a GUI display screen 311 (see FIG. 3A) of the portable device 310 in response to a rotation signal generated by a rotatable input interface 312 (see FIG. 3A) included in the portable device 310 at operation 210, scrolling through or searching a plurality of lower lists of the menu in response to a direction signal representing one direction, which is generated by a sensor included in the input interface 312 at operation 220, and selecting a desired item from the menu or the searched lower lists in response to an execution signal generated by the input interface at operation 230. It should be noted here that “selecting” in this context means choosing. It should not be confused with “selecting” for example, in the word processor sense, where “selecting” can mean to highlight a group of text, e.g. by double clicking on a single word.

In more detail, the menu is navigated or moved through in a rotation direction with respect to the display screen 311 of the portable device 310 in response to a rotation signal generated by the rotatable input interface 312 at operation 210, a plurality of lower lists of the menu are searched by using a sensor 313 (see FIG. 3A) included in the input interface 312 in order to search the lists for a desired item, e.g., upward/downward or left/right direction according to the layout of the lists at operation 220, and then the searched for item is selected and executed in response to a signal commanding that the searched for item be executed operation 230. The rotation signal and the direction signal may or may not be used interchangeably with each other according to the layout of a GUI menu and the shape and arrangement of the input interface 312.

Accordingly, it is possible to easily process various input operations by using one input interface capable of performing operations 210 through 230 in an integrated manner.

In detail, in operation 210, in order to move through a menu displayed on the display screen 311 of the portable device 310 by using a rotation signal generated by the rotatable input interface 312, the menu can be navigated or moved through in the same direction in which the input interface 312 is rotated. That is, the menu can be intuitively navigated by equalizing the direction in which the menu is displayed on the display screen 311 with the direction in which the input interface 312 is rotated. That is to say, if the input interface 312 is rotated to the left (i.e. counterclockwise), then graphical elements in the display screen 311 will likewise appear to shift to the left.

In operation 220, when a plurality of lower lists are individually scrolled upon or searched from the menu using a direction signal generated by the input interface 312 having the sensor 313, searching is performed in one direction of a plurality of directions in which the lists are arranged. In this case, the lists are searched in response to a direction signal indicating one direction, which is generated based on the total number of nodes in the input interface 312 or the arrangement of the sensor 313 in the input interface 312. That is, the sensor 313 in the input interface 312 is a touch sensor, and the lists are searched in a direction in which a node of the touch sensor proceeds, which will be illustrated and discussed below.

Here, the touch sensor 313 is a sensor that senses a surface electromotive force generated by a user hand by using a charging or discharging operation of a capacitor.

In operation 230, when a desired item is selected from the menu or the searched lists, a click signal input via the input interface may be considered an execution signal. In general, clicking indicates generation of an on/off signal by applying pressure onto an input interface, similar to a button being pressed.

One touch or two touches generated by the touch sensor 313 used in operation 220 may be used as an execution signal. That is, if an item is to be executed after rotating or touch-scrolling the input interface 312, an execution signal can be generated by touching for a short time a predetermined point on the input interface once, by using the touch sensor 313. It should be noted that it is common for such input interfaces 312 that any point along its length may touched for a short time in order to generate the execution signal.

Also, different clock or touch signals may be generated according to the arrangement of nodes included in the input interface. That is, if the touch sensor includes n nodes, n different execution signals may be generated according to the points of the respective n nodes.

An embodiment of such an input interface 312 according to the present invention will now be described in detail with reference to FIG. 3.

FIG. 3A illustrates an exploded view of input interface 312 included together with portable device 310 according to an embodiment of the present general inventive concept. The left portion of FIG. 3A illustrates the portable device 310 having a display unit 311, a main body 310a and an opening 310b. The right portion of FIG. 3A is a perspective view of the input interface 312, but in a much larger scale than the portable device 310. The input interface 312 is designed for rotatable, mating engagement with opening 310b.

FIG. 3B is a circuit block diagram illustrating the portable device 310 of FIG. 3A, according to one embodiment of the general inventive concept. The portable device 310 includes display unit 311, input interface 312, and an output unit 360 to output a signal to an external device. The output unit 360 may be a microprocessor, etc.

The input interface 312 may be embodied as a cylindrical or oval bar type and can be rotated clockwise or counterclockwise with respect to a Y-axis as illustrated in FIG. 3. That is, the input interface 312 can be rotated from a point a to a point b clockwise or counterclockwise as indicated with reference numeral 312-1. A rotation signal may be generated by rotating the input interface 312 by half the circumference (from the point “a” to the point “b” as illustrated) of a cylindrical bar shaped cross-section of the input interface 312, that is, by 180°. Alternatively, the rotation signal may be generated by rotating the input interface 312 by a quarter of the circumference of the cross-section, i.e., by 90°, or by 1/n of the circumference of the cross-section, i.e., by 360/n°.

Furthermore, a direction signal may be generated in a direction indicated by an arrow 312-2 along the Y-axis, by using touch sensor 313 included in the input interface 312, which is indicated with hatched lines. The direction of the direction signal is detected by the input interface 312 by sensing the pressure of a user's finger or the like and then tracking movement of the touch in one direction, using the touch sensor 313. That is, n touch nodes that constitute the touch sensor 313 are sequentially “on” or “off” depending on whether the input interface 312 is touched, and then the direction signal is generated in a direction in which the n nodes are sequentially “on”.

The input interface 312 may also be pushed downward as indicated with an arrow 312-3. In general, pushing of the input interface 312 is referred to as “clicking”.

According to the present general inventive concept, all rotating, touching, and clicking commands can be input using only one input interface 312.

The input interface 312 may be a combination of a plurality of bar type interfaces. For example, two or more interfaces may be connected to form the input interface 312.

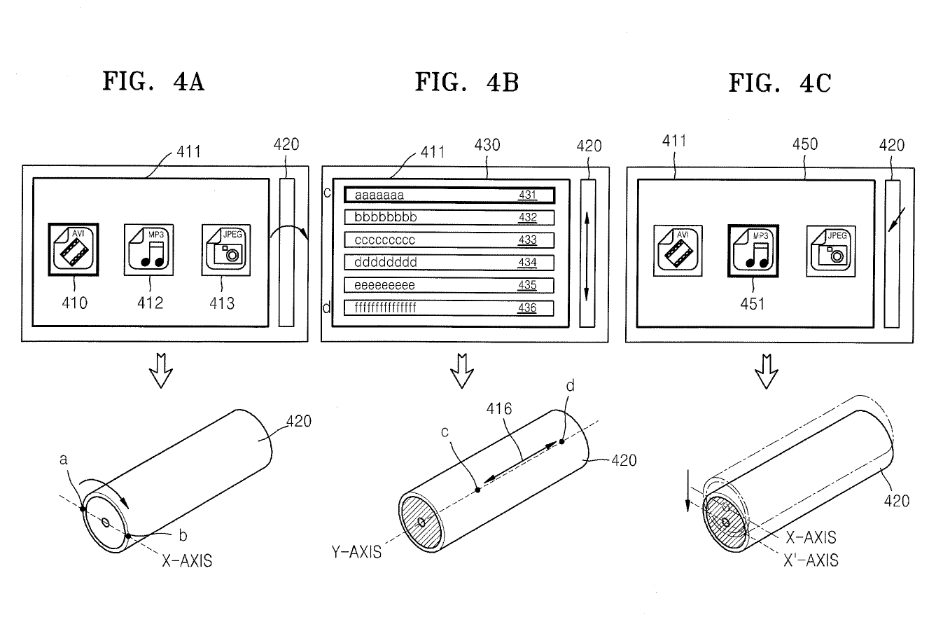

FIGS. 4A-4C illustrate various methods of handling a menu displayed on a GUI display screen 411, each figure illustrating the user interface separately in an exploded, perspective view, according to an embodiment of the present general inventive concept. It should be noted that GUI display screen 411 may be very similar in structure or function to display screen 311 of FIG. 3. Referring to FIG. 4A rotating of an input interface 420 is illustrated. It should be noted that input interface 420 may be very similar in structure or function to input interface 312 of FIG. 3. FIG. 4B illustrates touch-scrolling of the input interface 420 in one direction, as indicated by the arrow 416, and FIG. 4C illustrates clicking of input interface 420 for selecting a desired item.

Referring to FIG. 4A, the cylindrical bar type input interface 420 included in a portable device may be rotated clockwise or counterclockwise from a first point “a” to a second point “b”. That is, the input interface 420 may be rotated by half the circumference (from the point “a” to the point “b”) of a cylindrical bar type cross-section, i.e., by 180°. Alternatively, the input interface 420 may be rotated by a quarter of the circumference of the cross-section, i.e., by 90°, or by 1/n of the circumference, i.e., by 360/n°. As illustrated in FIG. 4A, if the input interface 420 is rotated clockwise from the point “a” to the point “b” highlighting of an item, so as to indicate that the item can be selected from among a plurality of items on the GUI screen, is also shifted or moved in a rightward direction. For example, if an item highlighted as a selectable item before rotating the input interface 420 is an “AVI” menu element 410, a highlight is moved from the “AVI” menu element 410 to another item, in this example an “MP3” menu element 412 after the input interface 420 is rotated.

Referring to FIG. 4B, if the input interface 420 is touched and scrolled in a Y-axis direction, it is possible to search from a first item “aaa” 431 to a last item “fff” 436 in a list of items included in a screen image 430 generated by display unit 411. For example, assuming that points “c” and “d” in a perspective view of the input interface 420 illustrated in FIG. 4B, are respectively located adjacent to the first item “aaa” 431 and the last item “fff” 436, if a user's finger touches the point “c” and then touch-scrolls to the point “d,” a highlight is shifted or moved from the first item “aaa” 431 to the second item “bbb” 432. Note that the highlighting of second item “bbb” 432 is not illustrated in FIGS. 4A through 4C. Also, the range of movement of a list of items on the screen by touching once may be variously set for the search from the first item “aaa” 431 to the last item “fff” 436, depending on the physical distance of touch-scrolling from the point “c” to the point “d.”

Referring to FIG. 4C, if a highlighted item MP3 451 is clicked on a shifted menu in a screen image 450 in order to select the item MP3 451, the item may be executed or a list lower in the menu structure than the item MP3 451 may be displayed. Note that what has been shifted in display screen 411 from FIG. 4A and 4C is the highlighting indicia (from AVI 410 in FIG. 4A to MP3 451 in FIG. 4C). Clicking a cylindrical bar type input interface 420 is illustrated in a perspective view illustrated in FIG. 4C. The clicking is performed by pushing the input interface 420 downward with respect to a dotted X-axis in order to move it in the direction of an X′-axis.

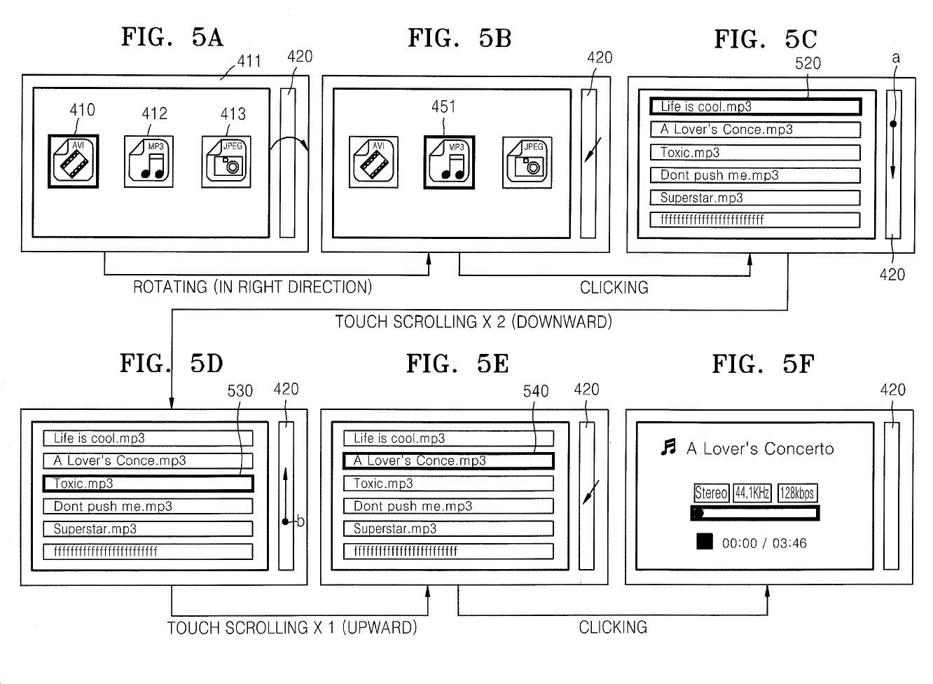

A scenario of searching for and executing a desired item will be described in detail with reference to FIGS. 5A-F.

FIGS. 5A-F are a flowchart illustrating a method of selecting a menu on a GUI screen 411 according to an embodiment of the present general inventive concept.

First, if the input interface 420 is rotated clockwise or in a rightward direction in the GUI screen 411 displaying “AVI 410”, “MP3 412”, and “JPEG 413” menu elements as illustrated in FIG. 5A, a highlight is moved from the highlighted “AVI” menu element 410 to the “MP3” menu 451 as illustrated in FIG. 5B. If the “MP3” menu 451 includes a list of lower items, the “MP3” menu element 451 is clicked, the list of lower items is displayed and then a “Life is cool.mp3” list element 520, which is the first item of the list associated with menu element 451, is highlighted as a selectable item (by clicking on input interface 420), as illustrated in FIG. 5C. In this case, if the input interface 420 is touch scrolled downward twice from a point “a,” a “Toxic.mp3” list element 530 which is a third item of the list is highlighted as a selectable item, as illustrated in FIG. 5D. Then if the input interface 420 is touch scrolled upward once from a point “b,” (as indicated in FIG. 5D) “A Lover's Conce.mp3” list element 540 which is a second item of the list is highlighted as a selectable item, as illustrated in FIG. 5E. Lastly, if “A Lover's Conce.mp3” list element 540 is clicked, a music file is reproduced as illustrated in FIG. 5F.

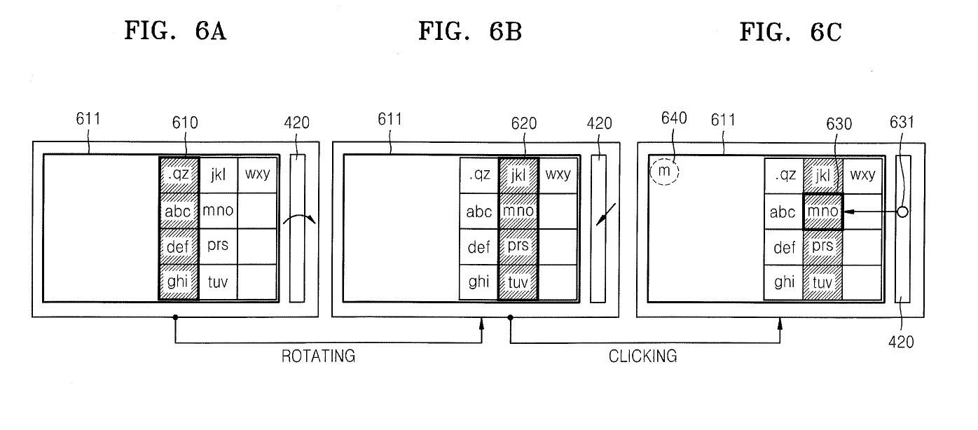

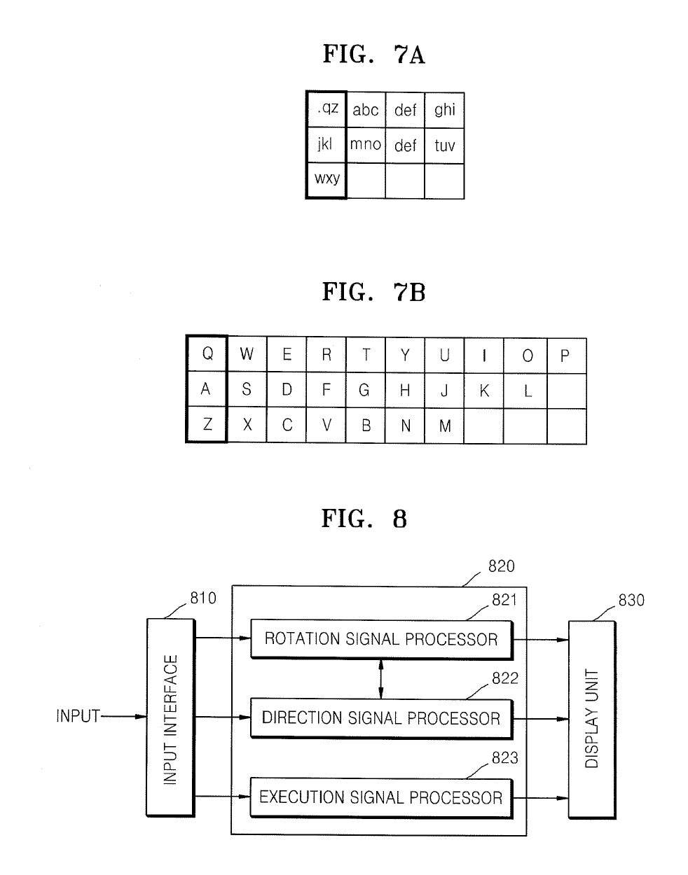

A method to control input interface 420 according to the present general inventive concept is capable of supporting the input of alphanumeric characters as illustrated in FIGS. 6A-C. In this case, letter characters can be variously arranged in a keyboard in which keys are arranged in a 4×3 matrix and a QWERTY keyboard (see FIG. 7B) which is a general computer keyboard. Inputting characters will now be described with reference to FIGS. 6 and 7.

FIGS. 6A-C illustrate a method of inputting characters according to an embodiment of the present general inventive concept.

A plurality of keys on a keyboard displayed on a screen may be divided into several rows, or parts in the vertical direction, according to the arrangement of touch nodes of an input interface 420. For example, if a touch node in the input interface 420 is divided into four parts, a first column or set of characters 610 that is displayed on a screen 611 can be divided into four rows, or parts in the vertical direction as illustrated in FIG. 6A. Thus it is possible to easily input a desired character from among the characters arranged in the vertical direction by clicking a corresponding part of the input interface 420. In an embodiment of the present general inventive concept, a plurality of characters that is divided into several parts may be visually displayed thereby increasing a user's convenience.

A case where the touch node in the input interface 420 is divided into four parts in the vertical direction will be described with reference to FIGS. 6A-C. First, the set of characters 610 in the first column is displayed as selectable item as illustrated in FIG. 6A and a second column or set of characters 620 is selected by rotating input interface 420 clockwise as illustrated in FIG. 6A. Then a character “m” included in a block or second row 630 of the second column of characters 620, for example, is input by clicking a point 631 of the input interface 420, as indicated by reference numeral 640. Alternatively, the other characters “n” and “o” belonging to the block or second row 630 that includes the “m” character may be input by continuously clicking the point 631 twice and three times, respectively.

As described above, various click signals can be generated according to the arrangement of touch sensor nodes in the input interface. That is, if four touch sensor nodes are present in the vertical direction, four different click signals that respectively correspond to the four touch sensor nodes can be generated.

Such a method of inputting characters, as described above, can be applied to both a keyboard with a 3×4 matrix illustrated in FIG. 7A and a QWERTY keyboard illustrated in FIG. 7B. A method of handling an input interface in order to input characters may be performed by using a combination of rotating, touch scrolling, and clicking as described above with reference to FIGS. 4A-C and FIGS. 5A-F, or by clicking a touch node without touch scrolling as described above with reference to FIGS. 6A-C.

FIG. 8 is a block diagram of a handling apparatus 820 included in a GUI-based portable device, according to an embodiment of the present general inventive concept. Referring to FIG. 8, the handling apparatus 820 includes a rotation signal processor 821 that navigates a menu displayed on a screen of the portable device in response to a rotation signal generated by a rotatable input interface included in the portable device, a direction signal processor 822 that searches a plurality of lower lists included in the menu in response to a direction signal generated by a sensor in an input interface 810 and indicating one direction, and an execution signal processor 823 that selects a desired item from the menu or the searched lower lists in response to an execution signal generated by the input interface 810.

Specifically, if an input signal is received via the input interface 810, the handling apparatus 820 transmits the input signal to one of the rotation signal processor 821, the direction signal processor 822, and the execution signal processor 823 according to the type of input signal, that is, according to whether the input signal indicates rotation, touch scrolling, or clicking. Here, the rotation signal and the direction signal may be interchangeably processed according to the layout of the displayed menu and the type of input interface. Each of the rotation signal processor 821, the direction signal processor 822, and the execution signal processor 823 controls a display 830 according to the received input signal.

The above method of handling a GUI-based portable device according to the present general inventive concept can be embodied as a computer program, and performed using a general digital computer capable of executing the program, via a computer readable medium.

The computer readable medium includes a magnetic storage medium (a ROM, a floppy disk, a hard disc, etc.), an optical storage medium (a CD ROM, a DVD, etc.), and a carrier wave that transmits data via the Internet, for example.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling a GUI (graphical user interface)-based portable device, the method comprising:
shifting indicia associated with a menu displayed on a screen of the portable device in response to a rotation signal generated by a rotatable input interface included in the portable device;
searching at least one of a plurality of lower lists included in the menu in a direction using a sensor included in the input interface, in response to a direction signal indicating the direction; and
selecting a desired item from the menu or the searched lower lists in response to an execution signal generated by the input interface.

2. The method of claim 1, wherein:
shifting indicia associated with the menu includes shifting highlighting indicia in the same direction the input interface is rotated.

3. The method of claim 2, wherein the searching of a plurality of lower lists comprises:
responding to the direction signal based proportionally on a total number or arrangement of nodes of a sensor included in the input interface.

4. The method of claim 3, wherein:
during the searching of a plurality of lower lists, the sensor in the input interface is a touch sensor; and
the plurality of lower lists is searched in a direction in which the nodes of the sensor are aligned.

5. The method of claim 4, wherein:
during the selecting of a desired item, the execution signal is a clock signal or a touch signal generated by the input interface; and
the click signal or the touch signal is differently generated according to the arrangement of nodes of the touch sensor included in the input interface.

6. The method of claim 5, wherein the input interface is a cylindrical or oval type bar interface.

7. The method of claim 6, wherein the input interface is formed of a combination of a plurality of bar type interfaces.

8. An apparatus to control a GUI (graphical user interface)-based portable device, the apparatus comprising:
a rotation signal processor for shifting elements in a menu displayed on a screen of the portable device in response to a rotation signal generated by a rotatable input interface included in the portable device;
a direction signal processor to search for a plurality of lower lists in the menu by using a sensor included in the input interface, in response to a direction signal indicating a direction; and
an execution signal processor to select a desired item from the menu or the searched lower lists in response to an execution signal generated by the input interface.

9. The apparatus of claim 8, wherein the rotation signal processor moves through the menu in a direction in which the input interface is rotated.

10. The apparatus of claim 9, wherein the direction signal processor searches the lists in the direction signal based on a total number or arrangement of nodes of the sensor in the input interface.

11. The apparatus of claim 10, wherein the sensor in the input interface is a touch sensor, and
the direction signal processor searches the lists in a direction in which the nodes of the touch sensor proceed.

12. The apparatus of claim 11, wherein the execution signal is a clock signal or a touch signal generated by the input interface, and
the execution signal processor selects the desired item in response to a click signal or a touch signal being differently generated according to the arrangement of nodes of the touch sensor included in the input interface.

13. The apparatus of claim 12, wherein the input interface is a cylindrical or oval bar type interface.

14. The apparatus of claim 13, wherein the input interface is formed of a combination of a plurality of bar type input interfaces.

15. A computer readable medium having recorded thereon a program to execute a method, the method comprising:
shifting indicia associated with a menu displayed on a screen of the portable device in response to a rotation signal generated by a rotatable input interface included in the portable device;
searching a plurality of lower lists included in the menu in a direction using a sensor included in the input interface, in response to a direction signal indicating the direction; and
selecting a desired item from the menu or the searched lower lists in response to an execution signal generated by the input interface.

16. An apparatus to control a portable device, comprising:
a frame;
an input interface rotatably disposed on the frame and having a touch screen to generate a rotation signal, a directive signal, and a selective signal; and
a display unit disposed on the frame to display a menu according to the rotation signal and an item selected by the selecting signal.

17. The apparatus of claim 16, wherein:
the interface has a first length; and
the display unit has a second length to correspond to the first length.

18. The apparatus of claim 16, wherein:
the interface has a rotation axis; and
the display unit displays the menu and the item along a display axis to correspond to the rotational axis.

19. The apparatus of claim 18, wherein:
the rotational axis is parallel to the display axis.

20. The apparatus of claim 16, wherein:
the main body includes an opening; and
the input interface includes a round surface exposed through the opening.

21. The apparatus of claim 16, wherein:
highlighting indicia generated by the display unit are shifted from one graphical element to another graphical element in the display unit, in response to an execution signal generated by rotation of the input interface.

22. The apparatus of claim 16, wherein:
the display unit generates a menu of graphical elements and selection of one graphical element followed by an execution signal generated by the input interface causes a list of items associated with the graphical element to be displayed in the display unit.

23. The apparatus of claim 16, wherein:
an execution signal is generated when a user double clicks on the input interface.

24. The apparatus of claim 23, wherein:
one item from the list is selected from the list when a user applies finger pressure along the input interface in a direction associated with the shifting of selection indicia with respect to the displayed list.

25. The apparatus of claim 24, wherein:
the input interface includes a sensor having a definite number of pressure-sensitive nodes, and, an alphanumeric character is selected from a set of alphanumeric characters in the list, the list having been previously subdivided into a predetermined number of sets equal to the number of nodes in the sensor of the input interface.
